(19) United States
(12) Patent Application Publication
(10) Pub. No.: US 2025/0249409 A1
(43) Pub. Date: Aug. 7, 2025

(54) ORGANIC SOLVENT ULTRAFILTRATION MEMBRANE OF POLYIMIDE/POLYETHYLENEIMINE@TiO2 WITH HIGH SOLVENT PERMEABILITY AND METHOD OF PRODUCING THE SAME

(71) Applicant: Zhejiang University of Technology, Hangzhou (CN)

(72) Inventors: Lifen LIU, Hangzhou (CN); Nijie LIU, Hangzhou (CN); Junyan YU, Hangzhou (CN); Xingyu CHEN, Hangzhou (CN)

(73) Assignee: Zhejiang University of Technology, Hangzhou (CN)

(21) Appl. No.: 19/023,256

(22) Filed: Jan. 15, 2025

(30) Foreign Application Priority Data
Feb. 6, 2024 (CN) 202410168429.5

(51) Int. Cl. B01D 67/00; B01D 61/14; B01D 69/02; B01D 69/12; B01D 71/60; B01D 71/64; C08J 3/24; C08J 5/24; C08K 9/08

(52) U.S. Cl. CPC B01D 67/0006; B01D 61/145; B01D 67/00111; B01D 67/00165; B01D 67/0097; B01D 69/02; B01D 69/1214; B01D 71/601; B01D 71/64; C08J 3/246; C08J 5/249; C08K 9/08; B01D 2323/30; B01D 2323/60; B01D 2325/04; B01D 2325/30; C08J 2379/08; C08J 2479/02

(57) ABSTRACT

The disclosure provides a solvent resistant polyimide/polyethyleneimine@titanium dioxide nanohybrid ultrafiltration membrane with high solvent permeability and a preparation method thereof. The preparation method comprises the following steps: dissolving a titanium dioxide precursor Ti-BALDH and polyimide into N-methylpyrrolidone to prepare a casting solution, then coating on the non-woven fabric, and preparing the solvent resistant nanohybrid polyimide membrane in one step through a non-solvent induced phase separation-interface crosslinking-in-situ biomimetic mineralization coupling method. According to the disclosure, a solvent resistant polyimide/polyethyleneimine@TiO₂ nanohybrid ultrafiltration membrane (PEIPI@TiO₂) with high solvent permeability prepared through a simple non-solvent induced phase separation-interface chemical crosslinking-in-situ bionic mineralization coupling method.

### CROSS-REFERENCE TO RELATED APPLICATIONS

This disclosure claims priority to Chinese Patent Application No. 202410168429.5, filed on Feb. 6, 2024, which is hereby incorporated by reference in its entirety.

### TECHNICAL FIELD

The disclosure relates to the technical field of membrane separation, in particular to a solvent resistant polyimide/polyethyleneimine@titanium dioxide nanohybrid ultrafiltration membrane (PI/PEI@TiO₂) with high solvent permeability and a preparation method thereof.

### BACKGROUND

Organic solvents are widely used in the fields of chemical industry, medicine, food and the like, with large usage and wide variety. Conventional separation methods such as distillation, extraction, adsorption and the like are used for the purification of organic products and the recovery of organic solvents, which have high energy consumption, long time consumption and low recovery rate. Compared with a conventional separation method, the membrane separation technology is energy-saving, efficient, simple to operate and easy to integrate. Therefore, the membrane separation technology has a wide application prospect in organic separation.

Ultrafiltration (UF) is a widely used membrane separation technology that uses pressure as a driving force and aims at separating large molecules from small molecules. The operating pressure of the UF membrane is generally 0 to 0.2 MPa, the pore size of the membrane is 2 nm to 50 nm, and the molecular weight (MWCO) of the trapped organic matter is 2000 to 500000. The existing commercial UF membrane has good stability and separation performance in an aqueous solution system. However, it is easy to swell or dissolve in many organic solvents, resulting in the loss of membrane performance, which limits its application range. In recent years, the membrane separation technology has shown huge application potential in product separation from organic solvent and the organic solvent recovery, such as the emerging solvent-resistant nanofiltration (SRNF) technology. The ultrafiltration membrane as the supporting membrane is critical to the performance stability of the SRNF membrane, and the ultrafiltration supporting membrane is required to have good organic solvent resistance. Similar in water treatment field, on the other hand, the UF membrane is normally used as the pretreat process of SRNF technology, requiring good organic solvent resistance. Therefore, the development of organic solvent ultrafiltration membrane (OSU), also called organic solvent resistant ultrafiltration membrane (OSRU) is of great significance for the separation application of membrane separation technology in organic solvent media.

However, only a few research on organic solvent ultrafiltration membranes (OSU) have been reported to date. Cao Yiming et al. used photoreactive polyethylene glycol diacrylate (PEGDA) as a polymerization monomer and ethanol as a solvent through ultraviolet irradiation to prepare the OSU membrane in the presence of photosensitizer. This prepared OSU membrane has a rejection rate of 20% to 60% for bovine serum albumin (BSA) and a pure water flux of 100 to 310 L/(m²·h), and it is also insoluble in common organic solvents such as methanol, ethanol and the like [J. Membr. Sci., 2008, 318 (1/2): 227-232]. In recent years, there have been many studies on the preparation of SRNF membranes, and most of the support membranes used are prepared with polyimide (PI) through non-solvent-induced phase transformation (NIPs). Since the PI has excellent thermodynamic performance, low temperature resistance and stable chemical properties, the ultrafiltration membrane prepared with PI has good tolerance to solvents such as alcohols, ketones, esters and the like. However, it is difficult to stably exist in polar aprotic solvents such as dimethylformamide (DMF), methyl pyrrolidone (NMP) and dimethyl sulfoxide (DMSO), and the solvent flux is low. It has been reported that the methods such as crosslinking modification [Prog. Polym. Sci., 2013, 38 (6): 874-896] and surface modification [J. Membr. Sci., 2003, 213 (1): 159-180] can improve the stability of PI membranes in aprotic polar solvents, but sacrifice solvent flux to a certain extent. In addition, Wang et al. [Sep. Purif. Technol., 2019, 227 (15): 115687] introduced the carbonized ZIF-8 nanoparticles into the polyimide membrane through a physical blending method, which synchronously improved the specific surface area, the pore size and the total porosity of the membrane, so that the flux of this membrane to the solvent such as ethanol was improved. However, the compatibility of the nanoparticles and the PI bulk polymer was poor, which led to the agglomeration of the nanoparticles in the membrane, resulting in a decrease in separation performance. Si et al. [Sep. Purif. Technol., 2020, 241 (15): 116545] added the aminated MCM-41 nanoparticles into the PI membrane. Since chemical bonds were formed between the nanoparticles and the polyimide to reduce agglomeration, the solvent flux of the membrane was improved without affecting the rejection rate. However, the nanohybrid modified PI membrane still has difficulty in tolerating the polar aprotic solvents such as DMF, NMP and DMSO.

### SUMMARY

The purpose of the present invention is to overcome the above-mentioned shortcomings of the prior art and provide a method for preparing a polyimide/polyethyleneimine@TiO₂ nanohybrid ultrafiltration membrane (PI/PEI@TiO₂) having a wide solvent resistant range and high solvent flux.

In one aspect, the present disclosure provides a method for preparing a polyimide/polyethyleneimine@titanium dioxide nanohybrid ultrafiltration membrane, the method comprises:
8 to 13 parts by mass of polyimide and 50 parts by mass of N-methylpyrrolidone (NMP) are mixed and stirred to form a uniform homogeneous solution;
1 to 5 parts by mass of a solution of titanium (IV) bis(ammonium lactato)dihydroxide (Ti-BALDH) containing 40 wt % to 60 wt % N-methylpyrrolidone is added to the homogeneous solution, stirred to be uniformly mixed, standing and defoaming to obtain a casting solution;
the casting solution is coated onto a non-woven fabric and placed in 1000 parts by mass of a coagulation bath aqueous solution containing polyethyleneimine, as a result of which the non-solvent induced phase separation, the polyimide crosslinking, and Ti-BALDH in-situ biomimetic mineralization catalyzed by polyethyleneimine are simultaneously carried out for 1 to 8 hours. After this, the residual cross-linking agent polyethyleneimine on the membrane surface is rinsed with deionized water, and the membrane is placed in ethanol for storage to remove residual solvent in the membrane, and finally the polyimide/polyethyleneimine@titanium dioxide nanohybrid ultrafiltration membrane is obtained.

Optionally, stirring is performed at 30° C. to 60° C. for 6 to 10 hours to form the homogeneous solution.

Optionally, the step of preparing the titanium (IV) bis(ammonium lactato)dihydroxide solution containing 40 wt % to 60 wt % N-methylpyrrolidone comprises: after the water in the Ti-BALDH aqueous solution is evaporated and removed, adding N-methylpyrrolidone thereto to obtain the titanium (IV) bis(ammonium lactato)dihydroxide solution containing 40 wt % to 60 wt % N-methylpyrrolidone.

Optionally, in the casting solution, calculated as 100% by weight, the weight percentages of the polyimide, NMP, Ti-BALDH are:

| | |
|---|---|
| polyimide | 16 wt %; |
| Ti-BALDH | 0 wt % to 6.5 wt %; |
| NMP | balance. |

Optionally, after stirring at 30° C. to 60° C. for 12 to 24 hours, let the casting solution stand for 12 to 24 hours for defoaming.

Optionally, the concentration of polyethyleneimine in the coagulation bath aqueous solution containing polyethyleneimine is 1.5 wt % to 3.5 wt %.

Optionally, the polyethyleneimine has a molar molecular weight of 300 to 70000.

Optionally, the configuration of the polyethyleneimine is branched polyethyleneimine or/and linear polyethyleneimine.

Optionally, the membrane thickness of the casting solution coated on the non-woven fabric is 150 to 250 micrometers.

In another aspect, the present disclosure provides a solvent resistant polyimide/polyethyleneimine@titanium dioxide nanohybrid ultrafiltration membrane with high solvent permeability prepared by the above method.

### BRIEF DESCRIPTION OF THE DRAWINGS

FIG. 1 is a Fourier attenuation total reflection infrared spectra (ATR-FTIR) of the non-crosslinked polyimide ultrafiltration membrane (PI) according to Comparative Example 1 of the present disclosure, the crosslinked polyimide/polyethyleneimine ultrafiltration membrane (PI/PEI) without titanium dioxide mineralization according to Example 4 of the present disclosure, and the crosslinked polyimide/polyethyleneimine@TiO₂ nanohybrid ultrafiltration membrane (PI/PEI@TiO₂) with a precursor content of 3.1 wt % according to Example 2 of the present disclosure.

FIG. 2 is an X-ray photoelectron spectroscopy (XPS) graph of the crosslinked polyimide/polyethyleneimine ultrafiltration membrane (PI/PEI) without titanium dioxide mineralization according to Example 4 of the present disclosure, and the crosslinked polyimide/polyethyleneimine@TiO₂ nanohybrid ultrafiltration membrane (PI/PEI@TiO₂) with a precursor content of 3.1 wt % according to Example 2 of the present disclosure.

FIG. 3 is a photograph of the non-crosslinked polyimide ultrafiltration membrane (PI) according to Comparative Example 1 of the present disclosure, the crosslinked polyimide/polyethyleneimine ultrafiltration membrane (PI/PEI) without titanium dioxide mineralization according to Example 4 of the present disclosure, and the crosslinked polyimide/polyethyleneimine@TiO₂ nanohybrid ultrafiltration membrane (PI/PEI@TiO₂) with a precursor content of 3.1 wt % according to Example 2 of the present disclosure before and after being immersed in DMF for 5 days.

FIG. 4 is an SEM image of the cross-linked polyimide/polyethyleneimine ultrafiltration membrane (PI/PEI) without titanium dioxide mineralization according to Example 4 of the present disclosure, and the crosslinked polyimide/polyethyleneimine@TiO₂ nanohybrid ultrafiltration membrane (PI/PEI@TiO₂) with a precursor content of 3.1 wt % according to Example 2 of the present disclosure before and after being immersed in DMF for 5 days.

### DETAILED DESCRIPTION

The present disclosure will be further described in detail below with reference to specific embodiments, but the content and scope of the invention of this patent are not limited to the following embodiments, and all changes or improved embodiments should be included within the scope of the present invention without departing from the content and scope of the present invention.

The purpose of the present invention is to overcome the shortcomings of the prior art and provide a method for preparing a polyimide/polyethyleneimine@TiO₂ nanohybrid ultrafiltration membrane (PI/PEI@TiO₂) having a wide solvent resistant range and high solvent flux.

The method for preparing the solvent resistant high-flux PEI/PI@TiO₂ ultrafiltration membrane comprises the following steps: firstly, a casting solution of titanium (IV) bis(ammonium lactato)dihydroxide (Ti-BALDH) and polyimide uniformly mixed is coated on the surface of the non-woven fabric to form a liquid film; then, it is placed into the coagulation bath aqueous solution containing polyethyleneimine to simultaneously carry out the non-solvent induced phase separation, the chemical crosslinking of polyethyleneimine and polyimide, and Ti-BALDH in-situ biomimetic mineralization catalyzed by polyethyleneimine. Since polyethyleneimine can chemically crosslink with polyimide, the membrane has excellent stability in highly polar aprotic solvents (such as DMF, NMP and DMSO), conventional polar solvents (such as alcohols and ketones), and non-polar solvents (such as n-hexane). Meanwhile, since polyethyleneimine has biomimetic mineralization effect on Ti-BALDH, titanium dioxide nanoparticles are generated in-situ in the membrane and are uniformly distributed. Compared with the conventional method for introducing the nanoparticle to modify membrane by physical blending, the method according to the present disclosure not only overcomes the agglomeration of the nanoparticles in the membrane but also improves the compatibility of the nanoparticles with the polymer body. In addition, the porosity of the membrane is adjusted by regulating the content of Ti-BALDH, thereby improving the solvent flux of the membrane without affecting the molecular rejection rate of the membrane.

The present invention proposes to prepare solvent resistant high-flux polyimide/polyethyleneimine@TiO₂ nanohybrid ultrafiltration membrane (PI/PEI@TiO₂) by a simple non-solvent induced phase separation-interfacial chemical crosslinking-in-situ biomimetic mineralization coupling method.

According to an embodiment of the present disclosure, there is provided a method for preparing a solvent resistant high-flux polyimide/polyethyleneimine@TiO₂ nanohybrid ultrafiltration membrane, comprising the following steps:
8 to 13 parts by mass of polyimide and 50 parts by mass of N-methylpyrrolidone (NMP) are mixed and stirred to form a uniform homogeneous solution;
1 to 5 parts by mass of a solution of titanium (IV) bis(ammonium lactato)dihydroxide (Ti-BALDH) containing 40 wt % to 60 wt % (most preferably 50 wt %) NMP is added to the homogeneous solution, stirred to be uniformly mixed, standing and defoaming to obtain a casting solution;
the casting solution is coated onto a non-woven fabric and quickly placed in 1000 parts by mass of a coagulation bath aqueous solution containing polyethyleneimine (preferably 15 to 35 parts by mass), as a result of which the non-solvent induced phase separation, the chemical crosslinking of polyethyleneimine and polyimide, and Ti-BALDH in-situ biomimetic mineralization catalyzed by polyethyleneimine are simultaneously carried out for 1 to 8 hours. After this, the residual crosslinking agent polyethyleneimine on the membrane surface is rinsed with deionized water, and the membrane is placed in ethanol for storage to remove residual solvent in the membrane, and finally the polyimide/polyethyleneimine@titanium dioxide nanohybrid ultrafiltration membrane is obtained.

Optionally, stirring is performed at 30° C. to 60° C. for 6 to 10 hours to form the homogeneous solution.

Optionally, the step of preparing the titanium (IV) bis(ammonium lactato)dihydroxide solution containing 40 wt % to 60 wt % N-methylpyrrolidone comprises: after evaporating water from 2 parts by mass of a Ti-BALDH solution containing 50 wt % of water, 1 part by mass of N-methylpyrrolidone (NMP) was added thereto to obtain 2 parts by mass of a Ti-BALDH mixed solution containing 50 wt % of NMP.

Optionally, in the casting solution, calculated as 100% by weight, the weight percentage of the polyimide, NMP, Ti-BALDH are:

| | |
|---|---|
| polyimide | 16 wt %; |
| Ti-BALDH | 0 wt % to 6.5 wt % (preferably 0.5 wt % to 6 wt %, |
| | more preferably 1.5 wt % to 3.5 wt %); |
| NMP | balance. |

Optionally, after stirring at 30° C. to 60° C. for 12 to 24 hours, let the casting solution stand for 12 to 24 hours for defoaming. Preferably, after stirring at 50° C. for 24 hours, let the casting solution stand for 12 hours for defoaming.

Optionally, an immersing time of the ultrafiltration membrane in the coagulation bath is 2 to 6 hours, and further preferably 3 hours.

Optionally, the concentration of polyethyleneimine in the coagulation bath aqueous solution containing polyethyleneimine is 1.5 wt % to 3.5 wt %., further preferably 2 wt % to 3 wt %, more preferably 2.5 wt %.

Optionally, the polyethyleneimine has a molar molecular weight of 300 to 70000, further preferably 300.

Optionally, the polyethyleneimine is branched polyethyleneimine or/and linear polyethyleneimine.

Optionally, the membrane thickness of the casting solution coated on the non-woven fabric is 150 to 250 micrometers, and further preferably 200 micrometers.

According to the disclosed method d for preparing the polyimide/polyethyleneimine@TiO₂ nanohybrid ultrafiltration membrane and the ultrafiltration membrane prepared therefrom, the following beneficial technical effects are produced compared with the prior art:

According to the method disclosed by the invention, the PEI and the TiO₂ nanoparticles are synchronously introduced into the PI ultrafiltration membrane through a simple non-solvent induced phase separation-interface chemical crosslinking-in-situ biomimetic mineralization coupling method. Since polyethyleneimine can chemically crosslink with polyimide, the membrane has excellent stability in highly polar aprotic solvents (such as DMF, NMP and DMSO), conventional polar solvents (such as alcohols and ketones), and non-polar solvents (such as n-hexane). Meanwhile, since polyethyleneimine has biomimetic mineralization effect on Ti-BALDH, titanium dioxide nanoparticles are generated in-situ in the membrane and are uniformly distributed. Compared with the conventional method for introducing the nanoparticle to modify membrane by physical blending, the method according to the present disclosure not only overcomes the agglomeration of the nanoparticles in the membrane but also improves the compatibility of the nanoparticles with the polymer body. In addition, the porosity of the membrane is adjusted by regulating the content of Ti-BALDH, thereby improving the solvent flux of the membrane without affecting the molecular rejection rate of the membrane.

### EXAMPLE

The technical solutions of the present disclosure are described in more detail below with reference to specific embodiments.

### Example 1

### 1. Preparation of Casting Solution

First, 10 g of PI (Matrimid® 5218) was dissolved in 50.4 mL of NMP and stirred at 50° C. for 8 hours. Then, 0.74 g of a Ti-BALDH mixed solution containing 50 wt % NMP was added dropwise to the solution under vigorous stirring, and stirred at 50° C. for 24 h, and allowed to stand for 12 h overnight for defoaming to obtain a uniform, bubble-free casting solution.

### 2. Non-Solvent Induced Phase Separation

The casting solution was evenly coated onto the non-woven fabric S53 to form a uniform liquid film by using a casting knife with 200 μm gap. Then, the non-woven fabric coated with the liquid film was immersed into 1 Kg aqueous solution containing 2.5 wt % of polyethyleneimine (300 molecular weight), as a result of which the non-solvent induced phase separation, the chemical crosslinking of polyethyleneimine and polyimide, and Ti-BALDH in-situ biomimetic mineralization catalyzed by polyethyleneimine were simultaneously carried out for 3 hours. The solvent resistant high-flux polyimide/polyethyleneimine@TiO₂ nanohybrid ultrafiltration membrane (PI/PEI@TiO₂) was thus obtained. The prepared membrane performance data are listed in Table 1.

### Example 2

The concentration of Ti-BALDH in step 1 was changed from 1.8 wt % to 3.1 wt %, and other operations were the same as in Example 1. The performance data of the prepared PI/PEI@TiO₂ membrane are listed in Table 1.

### Example 3

The concentration of Ti-BALDH in step 1 was changed from 1.8 wt % to 6.5 wt %, and other operations were the same as in Example 1. The performance data of the prepared PI/PEI@TiO₂ membrane are listed in Table 1.

### Example 4

The concentration of Ti-BALDH in step 1 was changed from 1.8 wt % to 0 wt %, and other operations were the same as in Example 1. The performance data of the prepared PI/PEI membrane are listed in Table 1.

### Comparative Example 1

The concentration of Ti-BALDH in step 1 was changed from 3.1 wt % to 0 wt %, the coagulation bath was changed from an aqueous solution of 2.5 wt % polyethyleneimine to pure water, and other operations were the same as those in Example 1. The performance data of the prepared PI membrane are listed in Table 1.

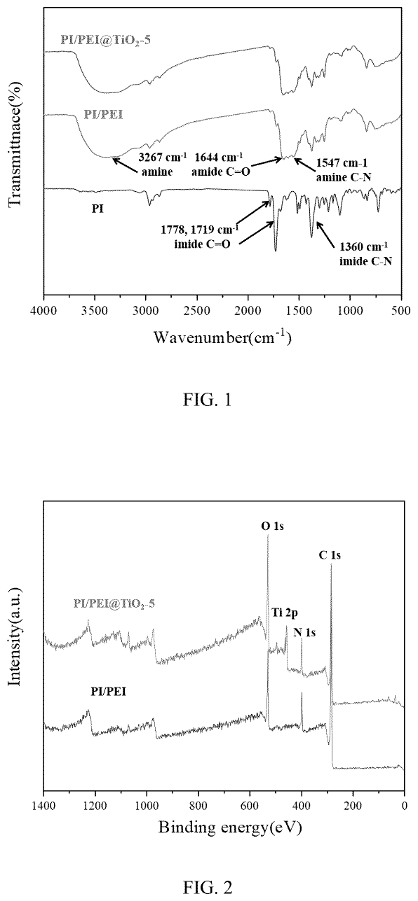

As shown in FIG. 1, the Fourier attenuation total reflection infrared spectra (ATR-FTIR) of polyimide/polyethyleneimine@titanium dioxide nanohybrid ultrafiltration membrane (PI/PEI@TiO₂-5) prepared with 3.1 wt % precursor Ti-BALDH in the casting solution and 5% TiO₂ (theoretical conversion rate), the crosslinked polyimide ultrafiltration membrane (PI/PEI) without the addition of precursor Ti-BALDH, and the non-crosslinked polyimide ultrafiltration membrane (PI).

As shown in FIG. 2, the X-ray photoelectron spectroscopy (XPS) graph of the polyimide/polyethyleneimine@titanium dioxide nanohybrid ultrafiltration membrane (PI/PEI@TiO₂-5) prepared with 3.1 wt % precursor Ti-BALDH in the casting solution and 5% TiO₂ (theoretical conversion rate), the crosslinked polyimide ultrafiltration membrane (PI/PEI) without the addition of precursor.

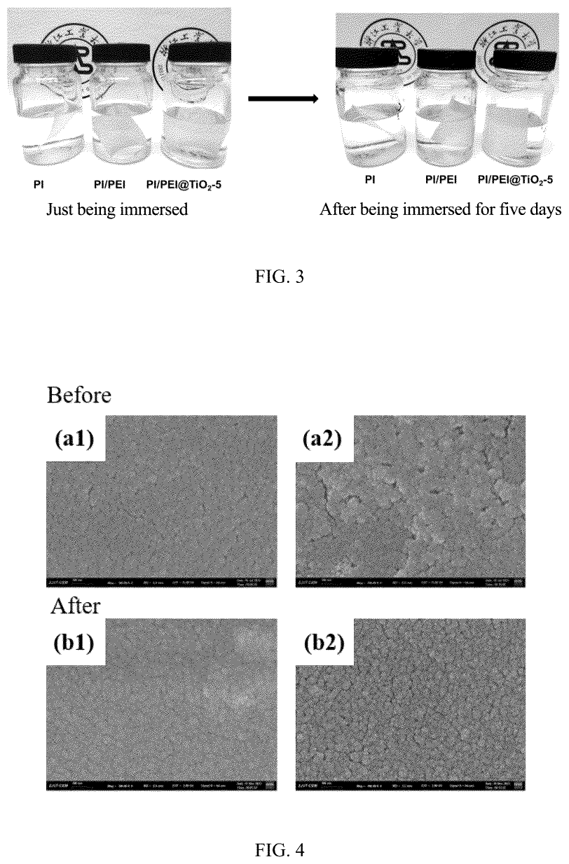

As shown in FIG. 3, the changes of polyimide/polyethyleneimine@ titanium dioxide nanohybrid ultrafiltration membrane (PI/PEI@TiO₂-5) prepared with 3.1 wt % precursor Ti-BALDH in the casting solution and 5% TiO₂ (theoretical conversion rate), the crosslinked polyimide ultrafiltration membrane (PI/PEI) without the addition of precursor, and the non-crosslinked polyimide ultrafiltration membrane (PI) before and after 5 days of immersion in DMF.

As shown in FIG. 4, the SEM image of polyimide/polyethyleneimine@titanium dioxide nanohybrid ultrafiltration membrane (PI/PEI@TiO₂-5) prepared with 3.1 wt % precursor Ti-BALDH in the casting solution and 5% TiO₂ (theoretical conversion rate), the crosslinked polyimide ultrafiltration membrane (PI/PEI) without the addition of precursor before and after 5 days of immersion in DMF.

TABLE 1
Separation performance of ultrafiltration membranes
prepared in Examples 1-4 and Comparative Example 1

| | | PEG-7W rejection |
|---|---|---|
| Example | DMF flux (L · m⁻² · h⁻¹ · bar⁻¹) | rate (%) |
| Example 1 | 59.4 | 94.3 |
| Example 2 | 65.4 | 95.3 |
| Example 3 | 58.4 | 85.0 |
| Example 4 | 50.7 | 95.0 |
| Comparative | None | None |
| Example 1 | | |

Note:
“None” means that the membrane is completely dissolved in the
solvent.
“PEG-7W” means 70000 Da of polyethylene glycol.

Three membranes prepared in Examples 2, 4 and Comparative Example 1 were selected as examples for testing solvent flux performance. The solvents tested were pure water, ethanol, n-hexane, NMP, DMSO and DMAc, respectively, and the test conditions were 25° C. and 0.2 MPa. The test results are shown in Table 2:

TABLE 2
Solvent Flux for Example 2, 4 and Comparative Example 1

| Solvent | Example 2 | Example 4 | Comparative Example 1 |
|---|---|---|---|
| Ethanol | 977 | 755.6 | 1580.0 |
| Pure water | 713.7 | 419.5 | 1077.2 |
| N-hexane | 6.5 | 5.1 | 14.7 |
| NMP | 48.5 | 39.4 | None |
| DMSO | 48.5 | 43.1 | None |
| DMAc | 74.9 | 45.2 | None |

Note:
“None” means that the membrane is completely dissolved in the solvent.

Three membranes prepared in Examples 2, 4 and Comparative Example 1 were selected as examples for testing solvent resistance. The membranes prepared in Examples 2, 4 and Comparative Example 1 were immersed in DMF for 5 days, then the flux of the membrane to pure DMF solvent and the rejection performance of 70,000 molecular weight polyethylene glycol (PEG-7W) in water were tested at 25° C. and 0.2 MPa. The test results are shown in Table 3:

TABLE 3
Changes in DMF flux and PEG-7W rejection rate of the
membranes prepared in Examples 2, 4 and Comparative
Example 1 after immersion in DMF solvent for 5 days

| | | | | | | Comparative |
|---|---|---|---|---|---|---|
| | Example 2 | Example 4 | Example 1 | Example 2 | Example 4 | Example 1 |
| | DMF flux | DMF flux | DMF flux | PEG-7W | PEG-7W | PEG-7W |
| | (L · m⁻² · | (L · m⁻² · | (L · m⁻² · | rejection | rejection | rejection |
| Days | h⁻¹ · bar⁻¹) | h⁻¹ · bar⁻¹) | h⁻¹ · bar⁻¹) | rate(%) | rate(%) | rate(%) |
| 0 | 64.4 | 50.6 | None | 95.3 | 95.1 | None |
| 1 | 87.7 | 68.8 | None | 92.2 | 95.2 | None |
| 2 | 80.6 | 53.1 | None | 95.0 | 90.7 | None |
| 3 | 72.2 | 53.1 | None | 94.5 | 94.8 | None |
| 4 | 71.4 | 49.7 | None | 95.9 | 96.4 | None |
| 5 | 87.6 | 54.5 | None | 94.7 | 94.4 | None |

Note
“None” means that the film is completely dissolved in the solvent.
“PEG-7W” means 70000 Da of polyethylene glycol.

According to the above results, the polyimide/polyethyleneimine@titanium dioxide nanohybrid ultrafiltration membrane (PI/PEI@TiO₂) prepared according to the method of the present disclosure has significantly improved solvent resistance compared to the traditional polyimide ultrafiltration membrane (PI); and, compared with a polyimide/polyethyleneimine ultrafiltration membrane (PI/PEI) that is only crosslinked, its DMF flux is significantly improved and the molecular retention rate remains stable. This confirms that the chemical crosslinking of polyethyleneimine can significantly improve the stability of conventional polyimide ultrafiltration membranes in organic solvents, and the introduction of TiO₂ through in-situ biomimetic mineralization can further improve the solvent flux of the membrane without affecting the molecular rejection rate of the membrane.

What is claimed is:

1. A method for preparing a solvent resistant polyimide/polyethyleneimine@titanium dioxide nanohybrid ultrafiltration membrane with high solvent permeability, the method comprises the following steps:
8 to 13 parts by mass of polyimide and 50 parts by mass of N-methylpyrrolidone (NMP) are mixed and stirred to form a uniform homogeneous solution;
1 to 5 parts by mass of a solution of titanium (IV) bis(ammonium lactato)dihydroxide (Ti-BALDH) containing 40 wt % to 60 wt % N-methylpyrrolidone is added to the homogeneous solution, and an uniformly mixed solution is obtained after being stirred, then let it stand for defoaming to obtain a casting solution;
the casting solution is coated onto a non-woven fabric, then the non-woven fabric is immersed into 1000 parts by mass of a coagulation bath aqueous solution containing polyethyleneimine, as a result of which the non-solvent induced phase separation, the chemical crosslinking of polyethyleneimine and polyimide, and Ti-BALDH in-situ biomimetic mineralization catalyzed by polyethyleneimine are simultaneously carried out for 1 to 8 hours, then the residual cross-linking agent polyethyleneimine on a membrane surface is rinsed with deionized water, and the membrane is placed in ethanol for storage to remove residual solvent, and finally the polyimide/polyethyleneimine@titanium dioxide nanohybrid ultrafiltration membrane is obtained.

2. The method according to claim 1, characterized in that the stirring is performed at 30 to 60° C. for 6 to 10 hours to form the homogeneous solution.

3. The method according to claim 1, characterized in that the step of preparing the titanium (IV) bis(ammonium lactato)dihydroxide solution containing 40 wt % to 60 wt % N-methylpyrrolidone comprises: after the water in the Ti-BALDH aqueous solution is removed by evaporation, adding N-methylpyrrolidone thereto to obtain the titanium (IV)bis(ammonium lactato)dihydroxide solution containing 40 wt % to 60 wt % N-methylpyrrolidone.

4. The method according to claim 1, characterized in that in the casting solution, calculated as 100% by weight, the weight percentages of the polyimide, NMP, Ti-BALDH are:

| | |
|---|---|
| polyimide | 16 wt %; |
| Ti-BALDH | 0 wt % to 6.5 wt %; |
| NMP | balance. |

5. The method according to claim 1, characterized in that after being stirred at 30 to 60° C. for 12 to 24 hours, the mixed casting solution stands for 12 to 24 hours for defoaming.

6. The method according to claim 1, characterized in that the concentration of polyethyleneimine in the coagulation bath aqueous solution containing polyethyleneimine is 1.5 to 3.5 wt %.

7. The method according to claim 1, characterized in that the polyethyleneimine has a molar molecular weight of 300 to 70000.

8. The method according to claim 1, characterized in that the polyethyleneimine is branched polyethyleneimine or/and linear polyethyleneimine.

9. The method according to claim 1, characterized in that the membrane thickness of the casting solution coated on the non-woven fabric is 150 to 250 micrometers.

10. A polyimide/polyethyleneimine@titanium nanohybrid dioxide ultrafiltration membrane prepared by the method according to claim 1.
